(19) United States
(12) Patent Application Publication
(10) Pub. No.: US 2009/0021447 A1
(43) Pub. Date: Jan. 22, 2009

(54) Alignment tool for directional antennas

(75) Inventors: Robert Wayne Austin, Huntsville, AL (US); Gregory A. Mercier, Madison, AL (US); Bruce Weddendorf, Huntsville, AL (US); Landon P. Eason, Orlando, FL (US)

Correspondence Address: Ralph A. Dowell of DOWELL & DOWELL P.C., 2111 Eisenhower Ave, Suite 406, Alexandria, VA, 22314, US

(73) Assignee: SUNSIGHT HOLDINGS, LLC, Oviedo, FL (US)

(21) Appl. No.: 12/155,760

(22) Filed: Jun. 9, 2008

Related U.S. Application Data
(60) Provisional application No. 60/929,023, filed on Jun. 8, 2007.

(51) Int. Cl. G01B 1/00; H01Q 1/12; G01B 5/24

(52) U.S. Cl. 343/880; 33/533

(57) ABSTRACT

A tool and method for aligning directional antennas quickly and accurately in azimuth, tilt and roll. The tool includes a housing, mounting brackets for securing the tool to an antenna, a data storage device including predetermined alignment information, a GPS system for measuring azimuth, and inclinometers for measuring tilt and roll. The tool also includes displays for displaying the measured values of the azimuth, tilt, and roll relative to the predetermined parameters. As a result, a user can easily align an antennas based on the azimuth, tilt, and roll information measured and displayed by the tool.

### CROSS-REFERENCE TO RELATED APPLICATIONS

This application claims priority to U.S. provisional patent application No. 60/929,023, which was filed on Jun. 8, 2007, and entitled “Alignment Tool for Directional Antennas,” and the subject matter of which is hereby incorporated by reference in its entirety.

### BACKGROUND OF THE INVENTION

1. Field of the Invention

The present invention relates to directional alignment and alignment systems for directional and planar pattern omni-directional antennas.

2. Brief Description of the Related Art

Alignment of directional and omni-directional antennas is important in a competitive industry with customers expecting uninterrupted cellular phone and other communications. See the reference paper “Impact of Mechanical Antenna Downtilt on Performance of WCDMA Cellular Network” and also the paper “Impacts of Antenna Azimuth and Tilt Installation Accuracy on UMTS Network Performance” by Bechtel Corp.

Current methods of aligning antennas accurately in azimuth involve the use of either complex surveying tools or geographic landmarks which must be correctly identified and surveyed before ascending a tower to install or align an antenna. These methods require special skills that many tower climbers do not have, are difficult to use and require much labor and time to implement. Traceability is also lacking. Attempts to document alignment to date include taking digital photographs of an antenna as installed and portraying the countryside in the background. Often a digital inclinometer is included in the photograph to record tilt. This method results in data that is difficult to verify, and may be altered using digital photograph manipulation. Also, azimuth cannot be accurately determined from a photograph. Those unfamiliar with the terrain find it difficult to determine the tower location from such photographs.

Surveying instruments can be used to align anything from antennas to buildings to roadways, but their universal and adaptable nature makes them complex to use. Only skilled personnel are able to get good results with this type of equipment, as each measurement is made manually. Documentation of alignments of directional antennas is now also time consuming and not verifiable, as it is done by hand from the readings from surveying instruments or by a crude photographic record with ambiguous results.

### SUMMARY OF THE INVENTION

The present invention is directed to a tool used to align directional antennas quickly and accurately in azimuth, tilt and roll and height above ground or elevation. This invention provides a tool that does not require extensive training or advanced skills to use accurately and that creates and maintains records of each antenna aligned for complete verifiable documentation. The tool can be preprogrammed with a database of tower sites and antenna alignment information for an entire network of antennas, and is able to automatically determine where it is and which antenna it is attached to. The record of alignment of each antenna will include the time, date, all alignment information, along with height of the antenna above ground level.

The present invention allows even unskilled laborers to accurately align directional antennas to specifications dictated by Network Engineering staff. The invention also aids an installer in aligning an antenna to such predefined specifications by alleviating the need for the installer to match numerical digits. By displaying a graphical interface, the tool clearly explains which direction to move the antenna to achieve the correct alignment.

The correct antenna is automatically determined, eliminating mistakes. The tool automatically generates and stores records of all alignment parameters including azimuth, tilt, and roll which parameters are related to the tower position, latitude and longitude, along with the height of the antenna above the ground. These records are easily read, transferred and printed using any personal computer. The combined records from an entire network of antennas may be accumulated and archived using an enterprise class database system.

### BRIEF DESCRIPTION OF THE DRAWINGS

A better understanding of the invention will be had with reference to the accompanying drawings wherein:

FIG. 1 is a front perspective illustrational view of the tool of the invention mounted to a directional antenna;

FIG. 2 is a front perspective view similar to FIG. 1 showing the entire antenna;

FIG. 3 is an assembly view showing the tool of FIG. 1 with the tool spaced from the antenna;

FIG. 4 is a rear assembly view of the tool as shown in FIG. 3;

FIG. 5 is a cutaway view of the tool of the invention showing the internal components;

FIG. 6 is an enlarged bottom perspective view of a portion of the tool of the invention;

FIG. 7 is a front perspective view of a portion of the tool of the invention;

FIG. 8 is an enlarged view of a horizontal display of the tool of the invention; and

FIG. 9 is an enlarged view of a vertical display of the tool of the invention.

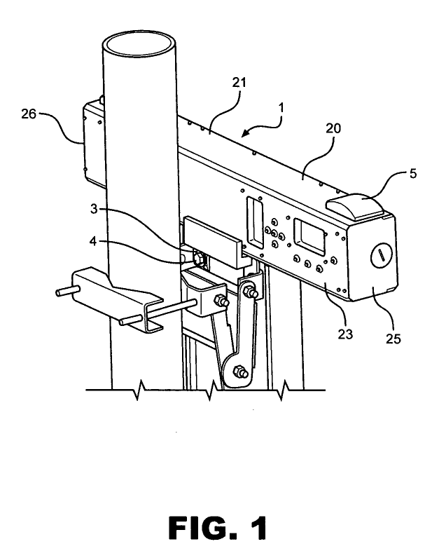

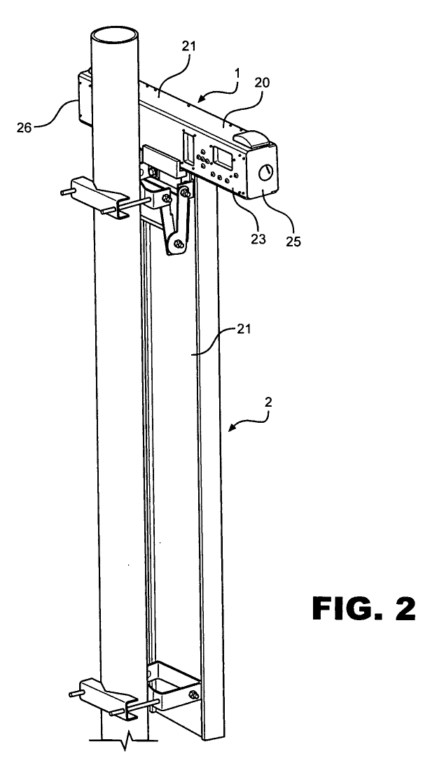

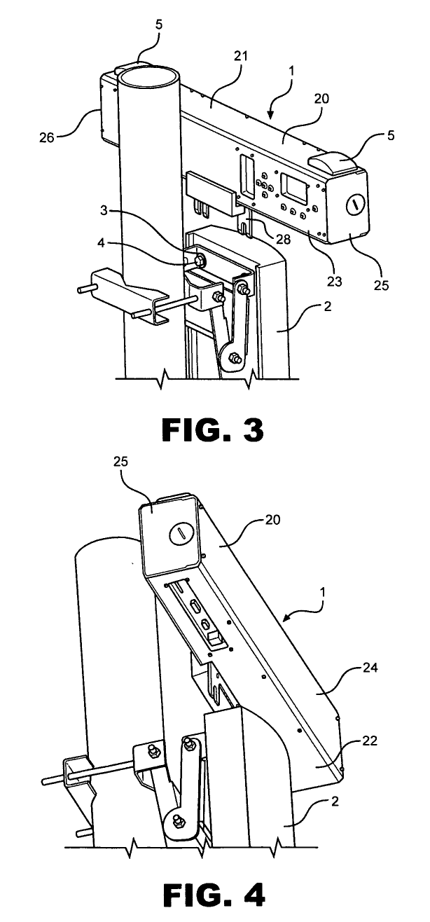

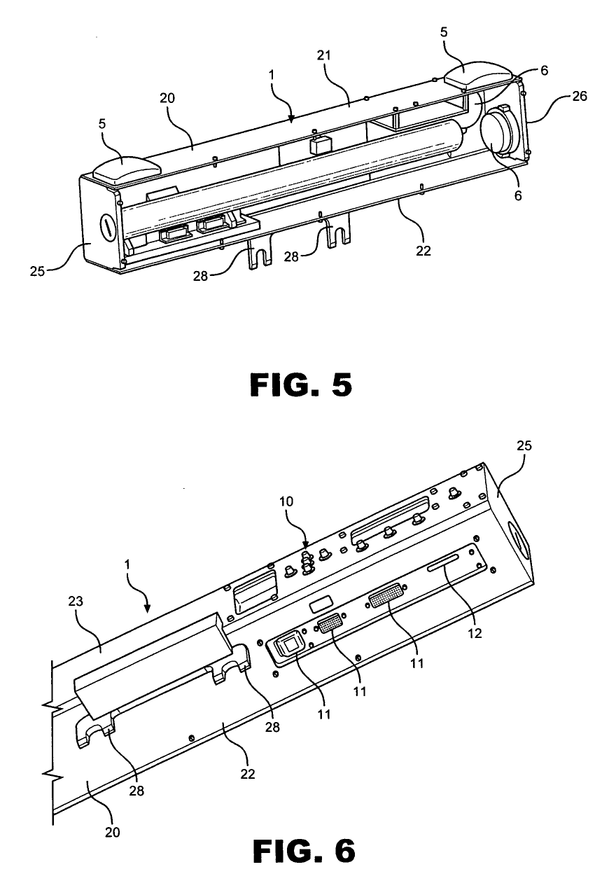

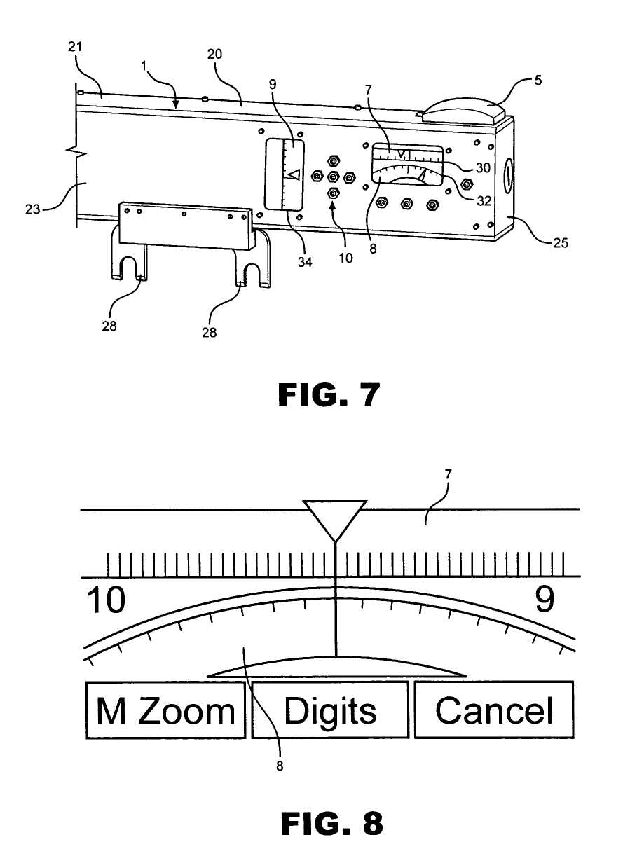

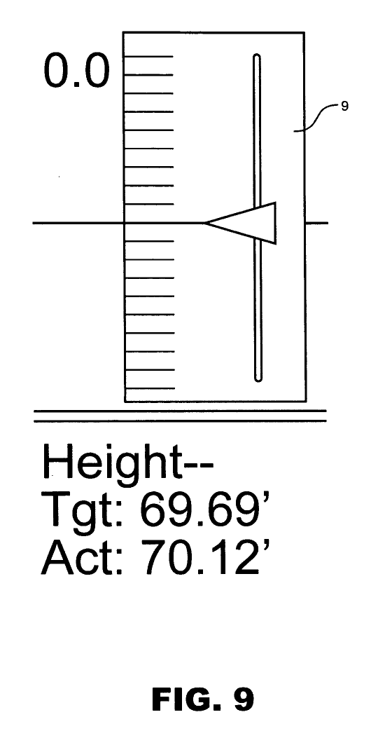

### DESCRIPTION OF THE PREFERRED EMBODIMENT

This invention is directed to a tool 1 used to align directional antennas quickly and accurately in azimuth, tilt and roll. The tool includes a housing 20 having an upper wall 21, lower wall 22, front wall 23, rear wall 24 and opposite end walls 25 and 26. A pair of inverted generally U-shaped mounting brackets 28 depend from the bottom wall 22 and are used to mount the tool to an antenna. The tool 1 mounts to an upper portion of a back surface 2′ of a directional antenna 2 temporarily by means of placing the mounting brackets 28 over mounting bolts 4 associated with a specialized antenna mounting bracket with washers 3 being used as clamps. In some instances, the tool 1 may be simply press by hand against the backplane of the antenna 2.

To determine azimuth, the tool 1 uses a GPS receiver with at least two antennas 5 spaced some distance apart. Computations of the difference in timing between the signals received by each GPS antenna 5 allow an accurate calculation of azimuth to be determined. See the reference paper: “Development of a GPS Multi-Antenna System for Attitude Determination,” Gang Lu, University of Calgary, 1995. Tilt and roll of the antenna is determined by electronic inclinometers 6 built into the rear wall 24 and the end wall 26 of the tool housing. The tilt is the angle the antenna makes with respect to the horizontal in the radiation direction, and the roll is the angle the antenna makes with respect to the horizontal in the cross radiation direction, at right angles to the radiation direction.

All information is presented graphically in a manner that communicates the spatial orientation of the tool 1, and thus the antenna 2 to which it is mounted, with respect to each pre-configured alignment parameter. The azimuth is represented by a horizontal linear designator 7, which moves left to right to highlight the current position in relation to the desired position, which is always centered on a display 30. The roll is represented by a designator 8 that traverses and moves along an arc shaped path relative to a display or scale 32. The designator 8 highlights the current roll alignment in relation to the desired position, which is always at top-center of the scale 32. The tilt is represented by a vertical linear designator 9, which moves from top to bottom of display or scale 34 to highlight the current position in relation to the desired position, which is always centered on the display 34. The sensitivity of each display is variable depending on proximity to the desired position. As the installer approaches the target alignment, the display becomes more sensitive to adjustments so that fine tuning may be accomplished near the desired position.

Easily manipulated switches 10 placed in a configuration that aids in understanding their function allow the user to set up the tool for use, accessing all features via menu choices. The tool 1 may be preprogrammed with a database of antenna alignment profiles including target azimuth, tilt and roll values for one or more antennas. The database is automatically accessed by the tool 1, which uses its knowledge of position from the GPS to narrow a list of relevant alignment profiles. Specific antennas on a tower cannot usually be determined by GPS information alone, as they are usually spaced too close to reliably resolve. This problem may be addressed in one of several ways. First, each antenna or antenna bracket could be equipped with an identifying chip which may be accessed either through an electrical connector or by radio frequency identification (RFID). Secondly, each antenna or antenna bracket could be labeled with a bar code or similar identifying marking which may be read using a scanner attached to the tool 1. Third, a communication protocol linking the antenna or other attached equipment could be used to determine the identity of a specific antenna.

A primary feature of the invention is the communication of installation alignment information to other entities in a network. Using a standard communication protocol, the invention interacts with other network entities to gather identification information and associate it with the captured record. By physically co-mounting the invention with a permanently mounted alignment monitor, for example, the installer may temporarily connect a short communication cable for this purpose. Ports 11 in the tool 1 allow this cable to be connected. After the alignment parameters have been met and the antenna mounting brackets 28 have been tightened, the installer may initiate communication and collect the identity of the installed network components to which it is connected, along with any other pertinent information. This data is stored in an onboard installation record and may be later archived in a corporate-wide enterprise class database system. A removable electronic data storage device 12 may be used for this purpose.

In addition, the tool 1 may also communicate with a standard off the shelf laser rangefinder {not shown) to determine the height of the antenna above the ground.

The foregoing description of the preferred embodiment of the invention has been presented to illustrate the principles of the invention and not to limit the invention to the particular embodiment illustrated. It is intended that the scope of the invention be defined by all of the embodiments encompassed within the following claims and their equivalents.

We claim:

1. A tool for aligning directional antennas, comprising:
a housing;
a securing means for securing the tool to an antenna;
a data storage device which contains data including a predetermined value for at least one alignment parameter for the antenna;
at least one measuring device which measures the at least one alignment parameter; and
at least one display which displays a measured value of the at least one alignment parameter relative to the predetermined value of the at least one alignment parameter.

2. The tool for aligning directional antennas set forth in claim 1, wherein the data contained in the data storage devices includes predetermined values for a plurality of alignment parameters for the antenna and wherein the tool further comprises:
a plurality of measuring devices, each measuring device measuring an alignment parameter for the antenna; and
a plurality of displays, each display displaying a measured value of an alignment parameter relative to the predetermined value for the alignment parameter.

3. The tool for aligning directional antennas set forth in claim 2, further comprising at least one port adapted to connect to a network.

4. The tool for aligning directional antennas set forth claim 2, further comprising at least one switch which enables a user to access the data contained in the data storage device.

5. The tool for aligning directional antennas set forth in claim 2, further including an identification means for identifying the antenna.

6. The tool for aligning directional antennas set forth in claim 5, wherein the identification means includes at least one selected from the group consisting of: an identifying chip, a radio frequency identification (RFID), a bar code, an identifying marking, and a communication protocol.

7. The tool for aligning directional antennas set forth in claim 2, wherein the plurality of measuring devices includes a GPS system having a GPS receiver and at least two antennas spaced some distance apart.

8. The tool for aligning directional antennas set forth in claim 7, wherein the plurality of measuring devices includes an inclinometer.

9. The tool for aligning directional antennas set forth in claim 2, wherein the plurality of alignment parameters include azimuth, tilt, and roll.

10. The tool for aligning directional antennas set forth in claim 2, wherein the data storage device is removably mounted to the tool.

11. A method for aligning directional antennas, comprising the steps of:
mounting a tool to an antenna, the tool including a housing, a securing means for securing the tool to an antenna, a data storage device which contains data including a predetermined value for at least one alignment parameter for the antenna, at least one measuring device which measures the alignment parameter, and at least one display which displays a measured value of the at least one alignment parameter relative to the predetermined value of the at least one alignment parameter;
measuring the at least one alignment parameter with the at least one measuring device;
displaying the measured value of the at least one alignment parameter relative to the predetermined value of the at least one alignment parameter on the at least one display; and
aligning the antenna based on the measure values of the at least alignment parameter relative to the predetermined value of the at least one alignment parameter as displayed on the at least one display.

12. The method for aligning directional antennas set forth in claim 11, wherein the data contained in the data storage devices includes predetermined values for a plurality of alignment parameters for the antenna and wherein the tool further includes a plurality of measuring devices, each measuring device measuring an alignment parameter for the antenna, and a plurality of displays, each display displaying a measured value of an alignment parameter relative to the predetermined value for the alignment parameter.

13. The method for aligning directional antennas set forth in claim 12, further comprising the step of connecting the tool to a network for communicating data including at least one alignment parameter.

14. The method for aligning directional antennas set forth in claim 12, wherein the tool further includes an identification means for identifying the antenna and wherein the method further comprises the step of identifying the antenna by the identification means.

15. The method for aligning directional antennas set forth in claim 14, wherein the identification means includes at least one selected from the group consisting of: an identifying chip, a radio frequency identification (RFID), a bar code, an identifying marking, and a communication protocol.

16. The method for aligning directional antennas set forth in claim 12, wherein the plurality of measuring devices includes a GPS system having a GPS receiver and at least two antennas spaced some distance apart.

17. The method for aligning directional antennas set forth in claim 16, wherein the plurality of measuring devices includes an inclinometer.

18. The method for aligning directional antennas set forth in claim 12, wherein the plurality of alignment parameters include azimuth, tilt, and roll.

19. The method for aligning directional antennas set forth in claim 12, further comprising the step of using the tool to communicate with a measuring means for determining a height of the antenna.

20. The method for aligning directional antennas set forth in claim 19 wherein the measuring means is a laser rangefinder.
